(19) United States
(12) Patent Application Publication
(10) Pub. No.: US 2008/0254683 A1
(43) Pub. Date: Oct. 16, 2008

(54) Electrical connector

(75) Inventors: Dong-Dong Si, Kunshan (CN); Chi Zhang, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/082,471

(22) Filed: Apr. 11, 2008

(30) Foreign Application Priority Data
Apr. 11, 2007 (CN) 200720035995.0

(51) Int. Cl. H01R 9/03

(52) U.S. Cl. 439/610

(57) ABSTRACT

A miniature electrical connector includes an insulating housing (10) comprising a first wall (121) and a second wall (122) parallel to the first wall (121) without end walls and defining a mating groove (13) between the first and second walls. A plurality of terminals (30, 40) is mounted in the insulating housing (10). A metallic shell (20) comprises a pair of opposite side walls (22, 23) and a pair of end walls (24) interconnecting the side walls. The metallic shell (20) encloses the housing (10) and defines a pair of guiding apertures (60) adjacent to and communicating with the mating groove (13) at opposite ends thereof, and the end walls (24) of the shell serve as end walls of the guiding apertures (60).

### BACKGROUND OF THE INVENTION

1. Field of the Invention

The present invention relates to an electrical connector, and particularly to an electrical connector including a metallic shell.

2. Description of the Prior Art

U.S. Pat. No. 6,966,789 discloses an electrical connector comprising an elongated insulating housing with a plurality of terminals mounted therein. The insulating housing comprises an upper wall, a lower wall and two opposite end walls connecting the upper wall and lower wall. A plurality of terminal receiving passageways is respectively defined in the upper wall and lower wall and a mating groove is defined therebetween. At each end of the mating groove, a guiding aperture is respectively defined adjacent to the end wall and runs through the insulating housing for receiving a guiding post of a mating connector. A metallic shell is provided to surround the insulating housing.

With the miniaturization trend of electrical connectors, the electrical connectors are becoming more and more thinner, lower and shorter. Obviously, the electrical connector disclosed above doesn't meet the demand of miniaturization, especially in length aspect. Therefore, a new design which is adapted for the new development is required.

### SUMMARY OF THE INVENTION

Accordingly, an object of the present invention is to provide a miniature electrical connector.

In order to achieve the object set forth, an electrical connector comprises an insulating housing comprising a first wall and a second wall parallel to the first wall without end walls and defining a mating groove between the first and second walls; a plurality of terminals mounted in the insulating housing; and a metallic shell comprising a pair of opposite side walls and a pair of end walls interconnecting the side walls; wherein the metallic shell encloses said housing and defines a pair of guiding apertures adjacent to and communicating with the mating groove at opposite ends thereof, and the end walls of the shell serve as end walls of the guiding apertures.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an electrical connector in accordance with the present invention;

FIG. 2 is another view of the electrical connector shown in FIG. 1;

FIG. 3 is an exploded perspective view of the electrical connector shown in FIG. 1;

FIG. 4 is a perspective view of an insulating housing and a shell of the electrical connector;

FIG. 5 is another view of the electrical connector shown in FIG. 2 with the shell taken out;

FIG. 6 is another view of the electrical connector shown in FIG. 1;

FIG. 7 is a front perspective view of the electrical connector shown in FIG. 1;

FIG. 8 is a cross-section view of the electrical connector shown in FIG. 7 along line 8-8; and

FIG. 9 is a cross-section view of the electrical connector shown in FIG. 7 along line 9-9.

### DETAILED DESCRIPTION OF THE INVENTION

Reference will now be made to the drawing figures to describe a preferred embodiment of the present invention in detail.

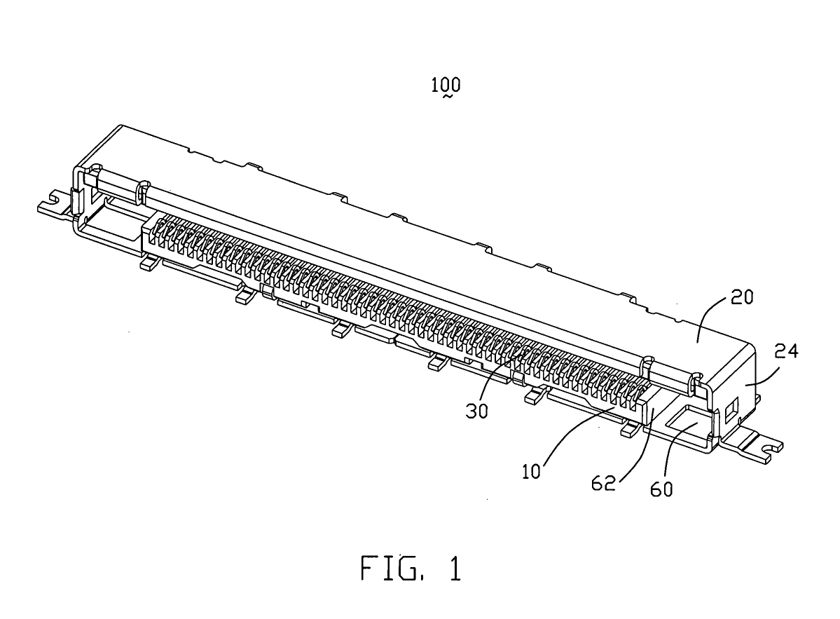

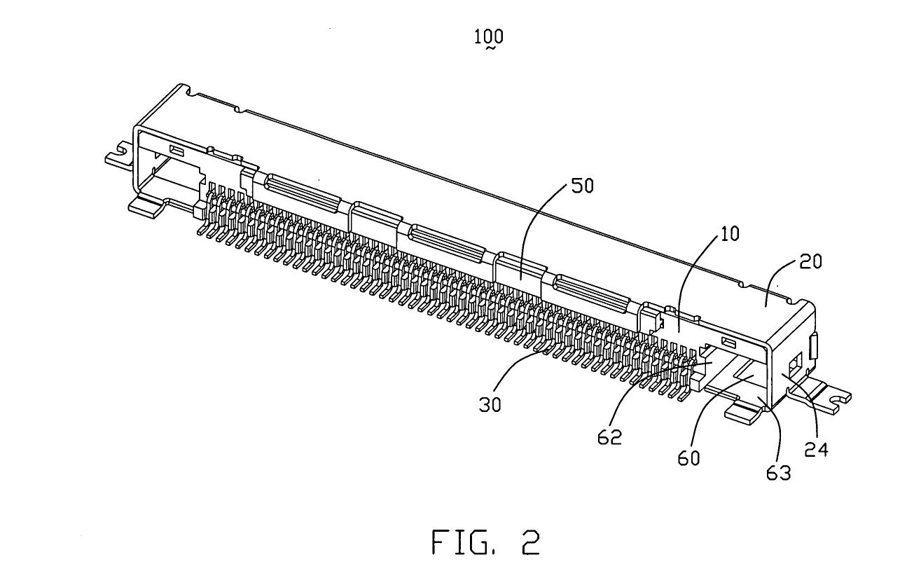

Referring to FIG. 1 to FIG. 3, an electrical connector 100 according to the present invention is provided and comprises an insulating housing 10, a metallic shell 20 surrounding the insulating housing 10, a plurality of conductive terminals 30 and grounding terminals 40 mounted in the insulating housing 10 and an insulating stopping board 50.

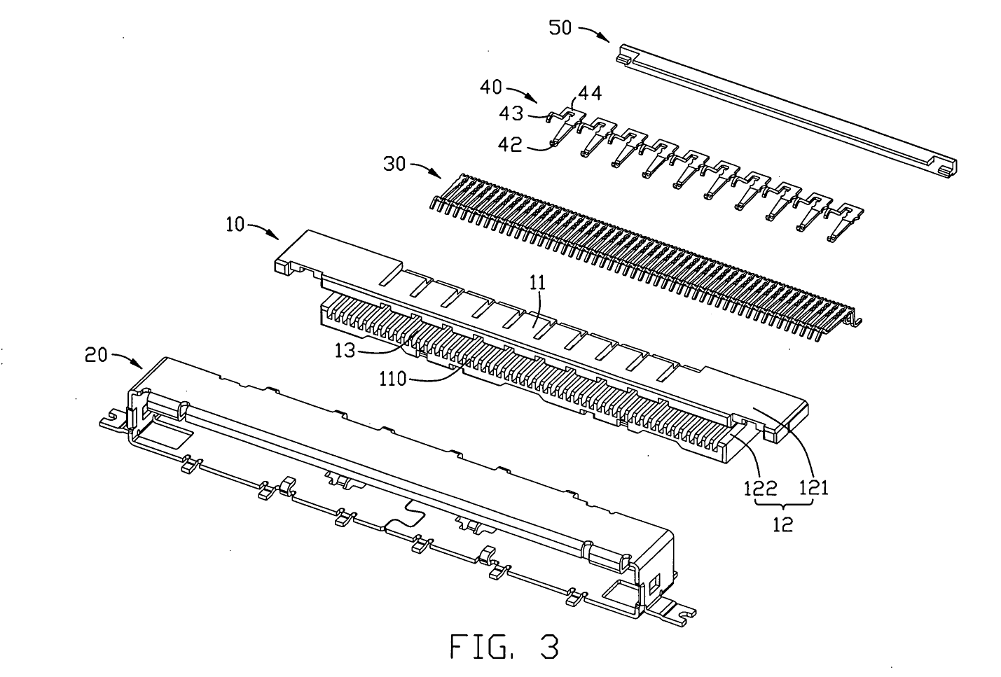

Referring to FIG. 3, the insulating housing 10 comprises an elongated base portion 11 and a mating portion 12 extending forward from the base portion 11. The mating portion 12 comprises a first wall 121 and a second wall 122 opposite and parallel to the first wall 121, thereby a mating groove 13 is defined therebetween. In this embodiment, the first wall 121 is longer than the second wall 122 in a longitudinal direction.

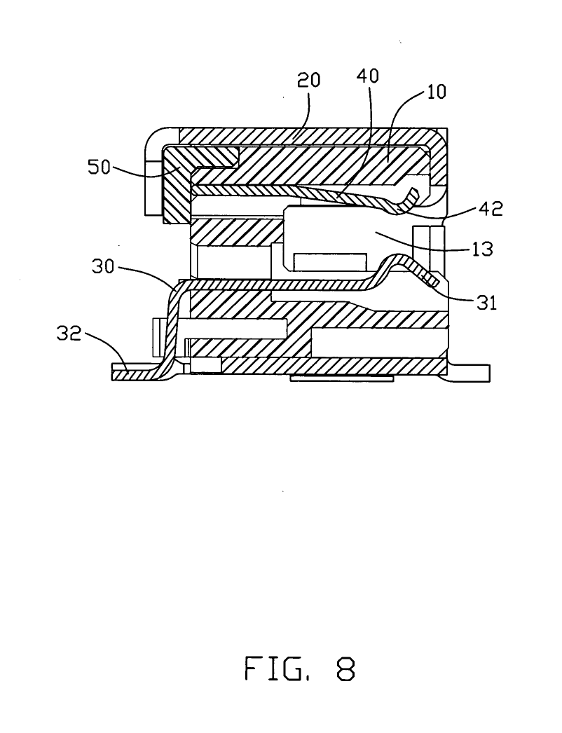

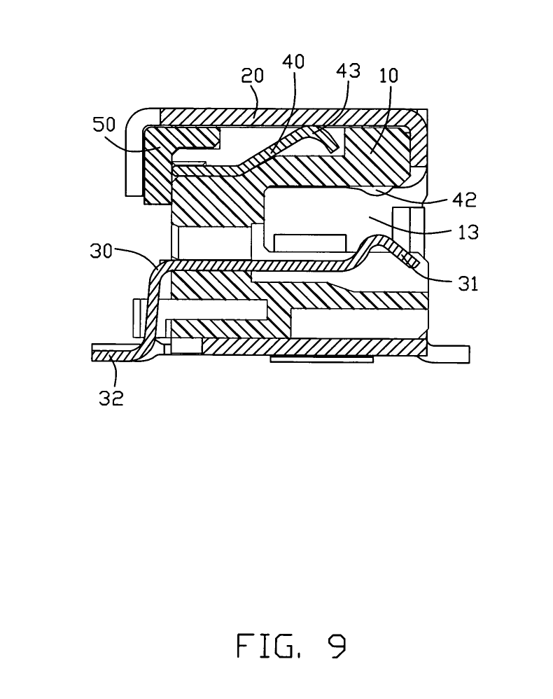

A plurality of terminal receiving passageways 110 is defined in the second wall 122 and runs through the base portion 11, the conductive terminals 30 are retained in the receiving passageways 110 with contacting portions 31 projecting to the mating groove 13 and solder portions 32 extending out of the insulating housing 10, as shown in FIG. 8. Each grounding terminal 40 is made by stamping a metal sheet and comprises a first arm 42 extending forward from one end of a body portion 44 and a second arm 43 upwardly extending from another end of the body portion 44. As FIGS. 8 and 9 shown, the first arm 42 is received in an inner surface of the first wall 121 and exposed to the mating groove 13. The second arm 43 is projecting out of an outer surface of the first wall 121 and connecting with the metallic shell 20. The mating groove 13 is defined between the conductive terminals 30 and grounding terminals 40 for mating with a mating connector.

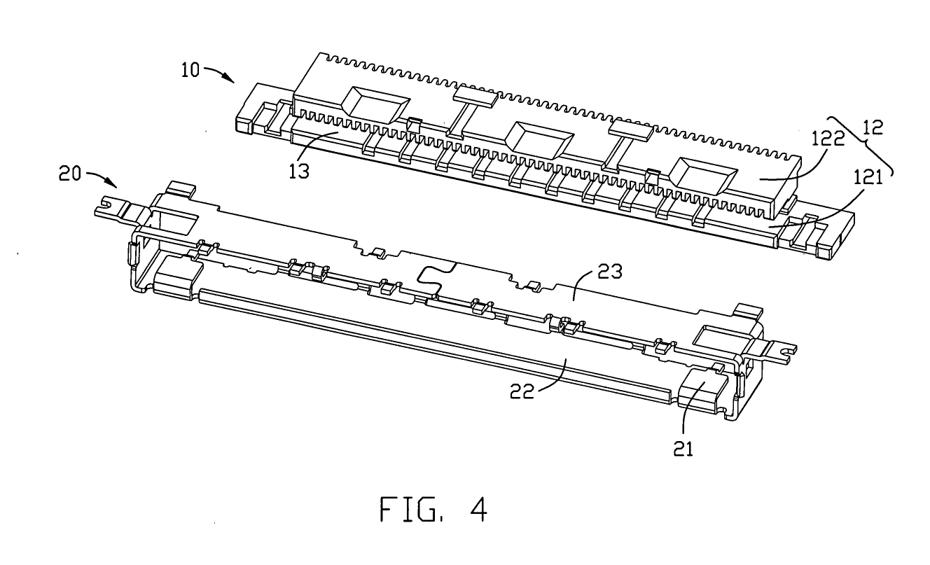

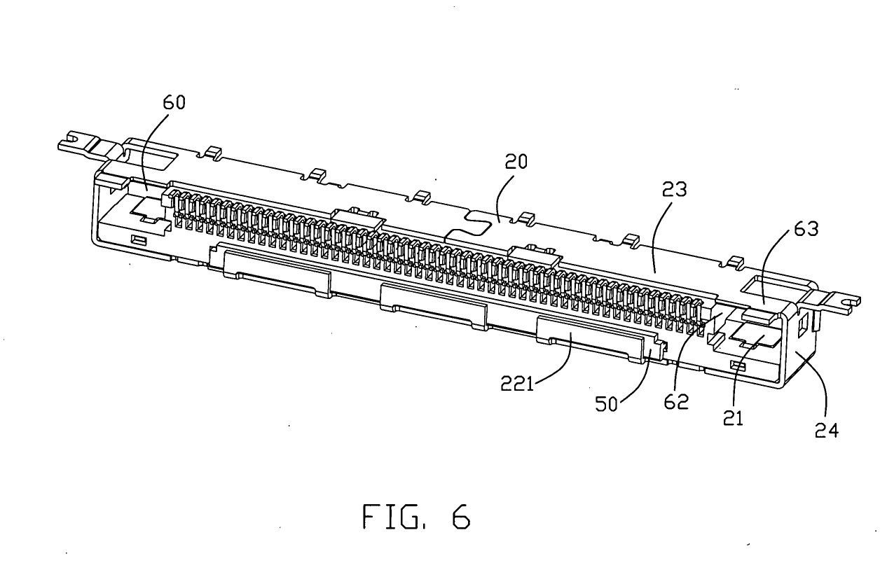

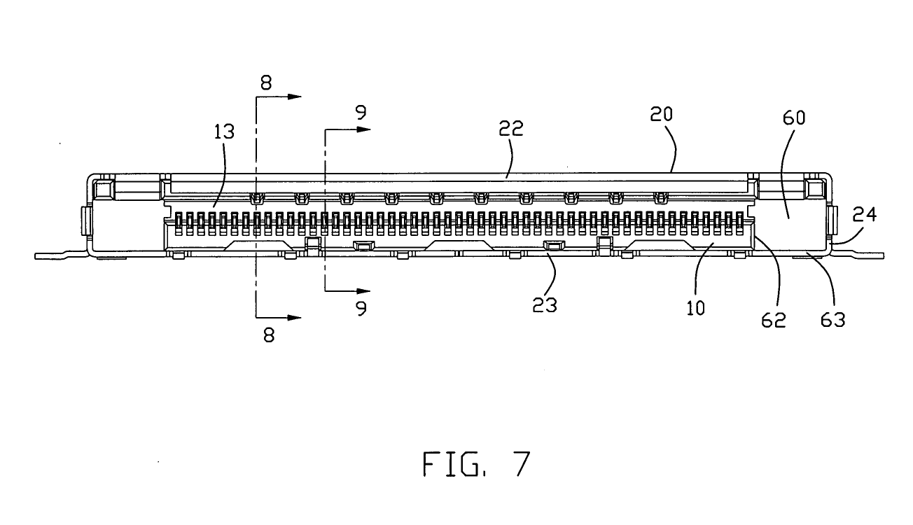

Referring to FIGS. 6 and 7, the metallic shell 20 is assembled on the outside of the insulating housing 10 and defines a pair of guiding apertures 60 at two opposite ends. The shell 20 is in a rectangle shape and comprises an upper wall 22, a lower wall 23 and two end walls 24 connecting with the upper wall 22 and lower wall 23. The upper wall 22 and the lower wall 23 are respectively covered on the first wall 121 and second wall 122 and the end walls 24 are engaging with two distal ends of the first wall 121 of the insulating housing 10. The second wall 122 of the insulating housing defines an end surface 62 facing an inner surface of the end wall 24 of the shell 20, so that the end surface 62 and the end wall 24 form end walls of the guiding aperture 60. As clearly shown in FIG. 4, a guiding piece 21 is respectively formed at a front edge of opposite ends of the upper wall 22 and bend inwardly to press against the inner surface of the first wall 121. As the first wall 121 is longer than the second wall 122 in the longitudinal direction, a portion 63 of the lower wall 23 serves as a side wall of the guiding aperture 60. That is to say, the first wall 121 and the portion 63 of the lower wall 23 together with the end surface 62 and inner surface of the end wall 24 define the guiding aperture 60 therebetween.

The guiding aperture 60 is adjacent to and communicating with the mating groove 13 in the longitudinal direction. The guiding aperture 60 and the mating groove 13 are both in the longitudinal direction, so that they are named a longitudinal slot surrounded by the first wall 121, the second wall 122 and end walls 24 of the shell. More, the guiding aperture 60 is wider than the mating groove 13 in a transverse direction perpendicular to the longitudinal direction.

The end walls 24 of the metallic shell 20 replace the insulating housing and serve as side walls of the guiding aperture 60, which is advantage for shortening the length of the electrical connector in the longitudinal direction and helpful to realize miniaturization. The second wall 122 is shorter than the first wall 121 in the longitudinal direction, so that the portion 63 of the lower wall 23 is provided to serve as side wall of the guiding aperture 60 and the height of the electrical connector is reduced. Moreover, the guiding aperture 60 is communicating with the mating groove 13, i.e. a front portion of opposite ends of the second wall 122 is separately from a same portion of the first wall 121, which is convenient for modeling the insulating housing. In this embodiment, two walls of the guiding aperture 60 are formed by the metallic shell 20, which can provide a steady fabric for a guiding post of the mating connector to insert into.

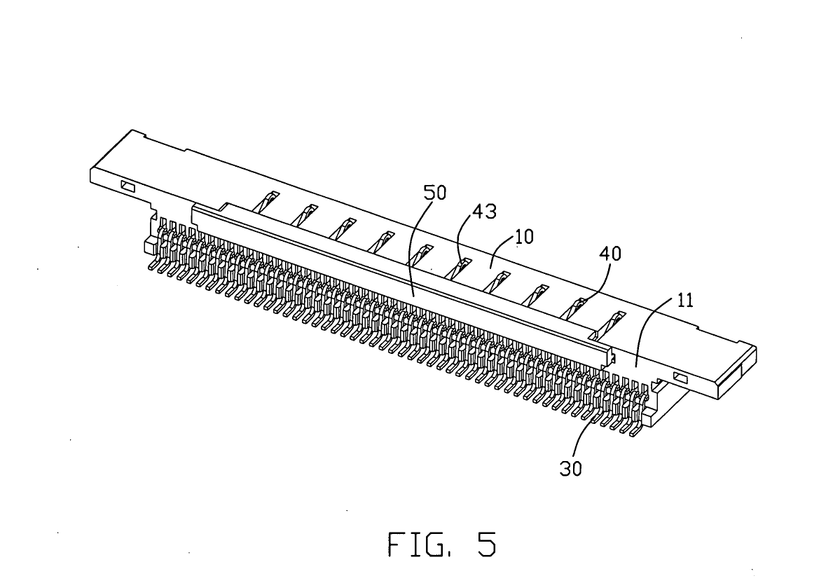

Referring to FIGS. 5 and 6, an insulating stopping board 50 in an elongated bar shaped is assembled on a rear portion of the first wall 121 and a holding portion 221 is formed at rear end of the upper wall 22 to urge with the stopping board 50 and prevent the grounding terminals 40 from backward moving.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector comprising:
an insulating housing comprising a first wall and a second wall parallel to the first wall without end walls and defining a mating groove between the first and second walls;
a plurality of terminals mounted in the insulating housing; and
a metallic shell comprising a pair of opposite side walls and a pair of end walls interconnecting the side walls;
wherein the metallic shell encloses said housing and defines a pair of guiding apertures adjacent to and communicating with the mating groove at opposite ends thereof, and the end walls of the shell serve as end walls of the guiding apertures.

2. The electrical connector as described in claim 1, wherein the second wall is shorter than the first wall in a longitudinal direction so that a portion of the side wall of the shell serves as a side wall of the guiding aperture.

3. The electrical connector as described in claim 2, wherein a pair of guiding pieces are respectively formed at front edge of opposite ends of one side wall and bent into the guiding aperture to press against the first wall.

4. The electrical connector as described in claim 2, wherein the second wall defines a pair of end surfaces facing the end walls of the shell, the end surface serves as an end wall of the guiding aperture.

5. The electrical connector as described in claim 2, wherein a front portion of opposite ends of the second wall is separately from a same portion of the first wall, so that the guiding aperture is communicating with the mating groove.

6. The electrical connector as described in claim 1, wherein a stopping board is assembled on the insulating housing, and a holding portion is formed at a rear end of the side wall to urge with the stopping board and prevent the terminals from backward moving.

7. An electrical connector comprising:
a metallic shell being in a hollow rectangle configuration and comprising a pair of side walls and end walls;
an insulating housing comprising a pair of opposite side walls and enclosed by the metallic shell, so as to form a longitudinal slot in a longitudinal direction, the longitudinal slot being surrounded by the side walls of the housing and the end walls of the shell;
a plurality of terminals arranged on at least one of the side walls of the housing and comprising contact portions;
wherein the longitudinal slot comprises a mating groove in which the contact portions extend and a pair of guiding apertures adjacent to ends of the mating groove.

8. The electrical connector as described in claim 7, wherein one side wall of the insulating housing is shorter than another side wall in the longitudinal direction so that the guiding aperture is surrounded by the end wall of the shell, one side wall of the shell and one side wall of the housing.

9. The electrical connector as described in claim 7, wherein the guiding aperture is wider than the mating groove in a transverse direction perpendicular to the longitudinal direction.

10. The electrical connector as described in claim 1, wherein only an end section of the first wall faces vertically the corresponding guiding aperture while that of the second wall not.

11. The electrical connector as described in claim 10, wherein said shell includes a guiding piece extending from a front edge thereof and folded over the end section of the first wall to form a part of boundary of the corresponding guiding aperture.

12. An electrical connector comprising:
an insulative elongated housing defining opposite first and second rows of passageways by two sides of a mating slot, each of said passageways extending along a front-to-back direction;
a metallic shell enclosing said housing;
a plurality of signal contacts disposed in the first row of passageways, respectively, with a signal mating section extending into the mating slot; and
a plurality of grounding contacts disposed in the second row of passageways, respectively, with a grounding mating section extending into the mating slot, each of said grounding contacts further defining an arm engaged with the shell; wherein
said grounding mating section and said arm both extending forwardly from a common body portion, and a stopping board is located behind and abuts against the body portion for retaining the grounding contact in position, and the shell defines a holding portion extending from a rear edge of the shell to abut against a rear face of the stopping board, under a condition that the signal contacts are not restrained by the stopping board, so that the grounding contacts are essentially fully protectively hidden behind a rear side of the connector while the signal contacts are rearward exposed to an exterior without protection from either the shell or the stopping board.
